(19) United States
(12) Patent Application Publication
(10) Pub. No.: US 2019/0092930 A1
(43) Pub. Date: Mar. 28, 2019

(54) RESIN COMPOSITION AND RESIN MOLDED BODY THEREOF

(71) Applicant: FUJI XEROX CO., LTD., Tokyo (JP)

(72) Inventors: Ryo TANAKA, Kanagawa (JP); Kenji YAO, Kanagawa (JP); Kana MIYAZAKI, Kanagawa (JP); Masahiro MORIYAMA, Kanagawa (JP)

(73) Assignee: FUJI XEROX CO., LTD., Tokyo (JP)

(21) Appl. No.: 15/943,404

(22) Filed: Apr. 2, 2018

(30) Foreign Application Priority Data
Sep. 26, 2017 (JP) 2017-184702

(51) Int. Cl. C08L 1/14; C08L 33/08; C08L 33/10; C08L 67/04; C08F 220/18

(52) U.S. Cl. CPC C08L 1/14; C08L 33/08; C08L 33/10; C08F 2800/20; C08F 220/18; C08L 2205/03; C08L 67/04

(57) ABSTRACT

A resin composition contains a cellulose ester compound (A), a poly(meth)acrylate compound (B) without a reactive group that reacts with a hydroxyl group of the cellulose ester compound (A), and a poly(meth)acrylate compound (C) with a reactive group that reacts with a hydroxyl group of the cellulose ester compound (A).

### CROSS-REFERENCE TO RELATED APPLICATIONS

This application is based on and claims priority under 35 USC 119 from Japanese Patent Application No. 2017-184702 filed Sep. 26, 2017.

### BACKGROUND

### (i) Technical Field

The present invention relates to a resin composition and a resin molded body thereof.

### (ii) Related Art

In the related art, various resin compositions are provided and used in different applications. Resin compositions are used particularly in, for example, various parts and housings of home appliances and automobiles. Thermoplastic resins are also used in parts, such as housings, of office machines and electrical and electronic devices.

In recent years, plant-derived resins have been used, and examples of plant-derived resins known in the art include cellulose ester compounds.

A molded body of a resin composition formed by adding a poly (meth)acrylate compound to a cellulose ester compound tends to have low transparency and have low tensile yield strength in a high-humidity/high-temperature environment.

### SUMMARY

According to an aspect of the invention, there is provided a resin composition containing a cellulose ester compound (A), a poly(meth)acrylate compound (B) without a reactive group that reacts with a hydroxyl group of the cellulose ester compound (A), and a poly(meth)acrylate compound (C) with a reactive group that reacts with a hydroxyl group of the cellulose ester compound (A).

### DETAILED DESCRIPTION

Exemplary embodiments of the present invention will be described below.

In this specification, the amount of each component in an object refers to, when there are several substances corresponding to the component in the object, the total amount of the substances present in the object, unless otherwise specified.

The expression “polymer of A” encompasses a homopolymer of only A and a copolymer of A and a monomer other than A. Similarly, the expression “copolymer of A and B” encompasses a copolymer of only A and B (hereinafter referred to as a “homocopolymer” for convenience) and a copolymer of A, B, and a monomer other than A and B.

A cellulose ester compound (A), a poly(meth)acrylate compound (B) without a reactive group that reacts with a hydroxyl group of the cellulose ester compound (A), and a poly(meth)acrylate compound (C) with a reactive group that reacts with a hydroxyl group of the cellulose ester compound (A) are also referred to as a component (A), a component (B), and a component (C), respectively.

Resin Composition

A resin composition according to an exemplary embodiment contains a cellulose ester compound (A), a poly(meth)acrylate compound (B) without a reactive group that reacts with a hydroxyl group of the cellulose ester compound (A), and a poly(meth)acrylate compound (C) with a reactive group that reacts with a hydroxyl group of the cellulose ester compound (A). The resin composition according to the exemplary embodiment may contain other components, such as a polyester resin (D).

The cellulose ester compound (A) (particularly cellulose acylate in which one or more hydroxyl groups are substituted with one or more acyl groups) is derived from a non-edible source and is an environmentally friendly resin material because it is a primary derivative without a need of chemical polymerization. The cellulose ester compound (A) has a high elastic modulus among resin materials and further has high transparency.

A molded body of a resin composition formed by adding a poly (meth)acrylate compound to a cellulose ester compound tends to have low transparency and have low tensile yield strength in a high-humidity/high-temperature environment. When the tensile yield strength of a resin molded body decreases in a high-humidity/high-temperature environment, it is difficult to use the molded body outdoors or in transportation by ship.

The resin composition according to the exemplary embodiment contains a cellulose ester compound (hereinafter referred to as a component (A)), a poly(meth)acrylate compound (hereinafter referred to as a component (B)) without a reactive group that reacts with a hydroxyl group of the cellulose ester compound (A), and a poly(meth)acrylate compound (hereinafter referred to as a component (C)) with a reactive group that reacts with a hydroxyl group of the cellulose ester compound (A). Such a composition provides a resin molded body in which a decrease in transparency may be suppressed and which may have a great ability to maintain its tensile yield strength in a high-humidity/high-temperature environment.

The effect of maintaining the tensile yield strength in a high-humidity/high-temperature environment may be as described below. Due to differences in affinity, kneading the component (A), the component (B), and the component (C) forms a cellulose ester phase (hereinafter referred to as a phase (A)) and a phase (hereinafter referred to as a phase (B+C)) in which the polyacrylate compounds (B) and (C) are compatible with each other. The reactive group moiety of the component (C) that reacts with a hydroxyl group of the cellulose ester compound (A) is unevenly distributed over the surface of the phase (B+C) because the reactive group moiety has low affinity with the acrylate moiety. When the resin composition formed by mixing these components is heated during kneading and molding, the hydroxyl group of the component (A) in the material being kneaded reacts with the reactive group of the component (C), so that the component (A) and the component (C) are linked to each other through covalent bonding, which is stable against heat and water. When the phase (A) and the phase (B+C) are linked to each other through covalent bonding, which is stable against heat and water, the interfacial strength between the phase (A) and the phase (B+C) becomes high. As a result, a resin molded body which may have a great ability to maintain its tensile yield strength in a high-humidity/high-temperature environment is obtained.

The effect of suppressing a decrease in transparency may be as described below.

Comparing the refractive index between the component (A) and the component (B), the refractive index of the component (B) is slightly higher than that of the component (A). When the component (A) and the component (B) each form a domain having a size of a visible wavelength or larger, a mixture of the component (A) and the component (B) has low transparency even though each component is transparent.

The component (C) reacts with both the component (A) and the component (B) and has affinity with each component. When a fine domain composed of the component (A)+the component (B)+the component (C) and having a size of a visible wavelength or smaller is formed, the resin composition may have high transparency.

Hereinafter, the components of the resin composition according to the exemplary embodiment will be described in detail.

### Cellulose Ester Compound (A): Component (A)

The cellulose ester compound (A) is, for example, a resin of a cellulose derivative (cellulose acylate) in which at least one or more hydroxyl groups in cellulose are substituted with one or more acyl groups (acylation). Specifically, the cellulose ester compound (A) is, for example, a cellulose derivative represented by general formula (CE).

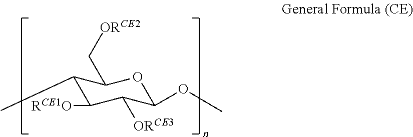

In general formula (CE), R^{CE1}, R^{CE2}, and R^{CE3} each independently represent a hydrogen atom or an acyl group, and n represents an integer of 2 or more. It is noted that at least one or more of n R^{CE1}'s, n R^{CE2}'s, and n R^{CE3}'s represent an acyl group.

The acyl groups represented by R^{CE1}, R^{CE2}, and R^{CE3} may be acyl groups having 1 or more and 6 or less carbon atoms.

In general formula (CE), n is preferably, but not necessarily, 200 or more and 1000 or less, and more preferably 500 or more and 1000 or less.

The expression “in general formula (CE), R^{CE1}, R^{CE2}, and R^{CE3} each independently represent an acyl group” means that at least one or more hydroxyl groups in the cellulose derivative represented by general formula (CE) are acylated.

Specifically, n R^{CE1}'s in the molecules of the cellulose derivative represented by general formula (CE) may be all the same, partially the same, or different from each other. The same applies to n R^{CE2}'S and n R^{CE3}'s.

The cellulose ester compound (A) may have, as an acyl group, an acyl group having 1 or more and 6 or less carbon atoms. In this case, a resin composition that provides a resin molded body in which a decrease in transparency may be suppressed and which may have a great ability to maintain its tensile yield strength in a high-humidity/high-temperature environment is obtained easily compared with the case where the cellulose ester compound (A) has an acyl group having 7 or more carbon atoms.

The acyl group has a structure represented by “—CO—R^{Ac}”, where R^{AC} represents a hydrogen atom or a hydrocarbon group (may be a hydrocarbon group having 1 or more and 5 or less carbon atoms).

The hydrocarbon group represented by R^{AC} may be a linear, branched, or cyclic hydrocarbon group, and is preferably a linear hydrocarbon group.

The hydrocarbon group represented by R^{AC} may be a saturated hydrocarbon group or an unsaturated hydrocarbon group, and is preferably a saturated hydrocarbon group.

The hydrocarbon group represented by R^{AC} may have atoms (e.g., oxygen, nitrogen) other than carbon and hydrogen, and is preferably a hydrocarbon group composed of carbon and hydrogen.

Examples of the acyl group include a formyl group, an acetyl group, a propionyl group, a butyryl group (butanoyl group), a propenoyl group, and a hexanoyl group.

Among these groups, the acyl group is preferably an acyl group having 2 or more and 4 or less carbon atoms and more preferably an acyl group having 2 or more and 3 or less carbon atoms in order to improve the moldability of the resin composition, suppress a decrease in the transparency of the obtained resin molded body, and maintain the tensile yield strength in a high-humidity/high-temperature environment.

Examples of the cellulose ester compound (A) include cellulose acetates (cellulose monoacetate, cellulose diacetate (DAC), and cellulose triacetate), cellulose acetate propionate (CAP), and cellulose acetate butyrate (CAB).

The cellulose ester compound (A) may be used alone or in combination of two or more.

Among these substances, the cellulose ester compound (A) is preferably cellulose acetate propionate (CAP) or cellulose acetate butyrate (CAB) and more preferably cellulose acetate propionate (CAP) in order to suppress a decrease in the transparency of the obtained resin molded body and maintain the tensile yield strength in a high-humidity/high-temperature environment.

The weight-average degree of polymerization of the cellulose ester compound (A) is preferably 200 or more and 1000 or less, and more preferably 500 or more and 1000 or less in order to improve the moldability of the resin composition, suppress a decrease in the transparency of the obtained resin molded body, and maintain the tensile yield strength in a high-humidity/high-temperature environment.

The weight-average degree of polymerization is calculated from the weight-average molecular weight (Mw) in the following manner.

First, the weight-average molecular weight (Mw) of the cellulose ester compound (A) is determined on a polystyrene basis with a gel permeation chromatography system (GPC system: HLC-8320GPC available from Tosoh Corporation, column: TSKgel α-M) using tetrahydrofuran.

Next, the weight-average molecular weight of the cellulose ester compound (A) is divided by the molecular weight of the structural unit of the cellulose ester compound (A) to produce the weight-average degree of polymerization of the cellulose ester compound (A). For example, when the substituent of cellulose acylate is an acetyl group, the molecular weight of the structural unit is 263 at a degree of substitution of 2.4, and 284 at a degree of substitution of 2.9.

The degree of substitution of the cellulose ester compound (A) is preferably 2.1 or more and 2.8 or less, more preferably 2.2 or more and 2.8 or less, still more preferably 2.3 or more and 2.75 or less, and yet still more preferably 2.35 or more and 2.75 or less in order to improve the moldability of the resin composition, suppress a decrease in the transparency of the obtained resin molded body, and maintain the tensile yield strength in a high-humidity/high-temperature environment.

In cellulose acetate propionate (CAP), the ratio of the degree of substitution with the acetyl group to the degree of substitution with the propionyl group (acetyl group/propionyl group) is preferably from 5/1 to 1/20 and more preferably from 4/1 to 1/15 in order to improve the moldability of the resin composition, suppress a decrease in the transparency of the obtained resin molded body, and maintain the tensile yield strength in a high-humidity/high-temperature environment.

In cellulose acetate butyrate (CAB), the ratio of the degree of substitution with the acetyl group to the degree of substitution with the butyryl group (acetyl group/butyryl group) is preferably from 5/1 to 1/20 and more preferably from 3/1 to 1/15 in order to improve the moldability of the resin composition, suppress a decrease in the transparency of the obtained resin molded body, and maintain the tensile yield strength in a high-humidity/high-temperature environment.

The degree of substitution indicates the degree at which the hydroxyl groups of cellulose are substituted with acyl groups. In other words, the degree of substitution indicates the degree of acylation of the cellulose ester compound (A). Specifically, the degree of substitution means the average number of hydroxyl groups per molecule substituted with acyl groups among three hydroxyl groups of the D-glucopyranose unit of cellulose acylate.

The degree of substitution is determined from the integration ratio between the peak from hydrogen of cellulose and the peak from the acyl group using H¹-NMR (JMN-ECA available from JEOL RESONANCE).

Poly(meth)acrylate Compound (B) without Reactive Group that Reacts with Hydroxyl Group of Cellulose Ester Compound (A): Component (B)

The poly(meth)acrylate compound (B) according to the exemplary embodiment is a compound (resin) with a structural unit derived from (meth)acrylate (preferably alkyl (meth)acrylate) and without a reactive group that reacts with a hydroxyl group of the cellulose ester compound (A).

The poly(meth)acrylate compound (B) may be a compound (resin) having a structural unit derived from a monomer other than (meth)acrylate. The poly(meth)acrylate compound (B) may have one structural unit (monomer-derived unit) or two or more structural units.

The poly(meth)acrylate compound (B) may be a compound (polymer) including 50 mass % or more (preferably 70 mass % or more, more preferably 90 mass %, still more preferably 100 mass %) of a structural unit derived from an alkyl (meth)acrylate in order to suppress a decrease in the transparency of the obtained resin molded body and maintain the tensile yield strength in a high-humidity/high-temperature environment.

Examples of the alkyl (meth)acrylate for the poly(meth)acrylate compound (B) include methyl (meth) acrylate, ethyl (meth) acrylate, n-propyl (meth) acrylate, n-butyl (meth) acrylate, n-pentyl (meth) acrylate, n-hexyl (meth) acrylate, n-heptyl (meth) acrylate, n-octyl (meth) acrylate, n-decyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth) acrylate, isooctyl (meth) acrylate, 2-ethylhexyl (meth)acrylate, octyl (meth)acrylate, decyl (meth)acrylate, cyclohexyl (meth)acrylate, and dicyclopentanil (meth) acrylate.

The poly(meth)acrylate compound (B) may be a polymer including 100 mass % of a structural unit derived from an alkyl (meth)acrylate having an alkyl chain with 1 or more and 8 or less carbon atoms (preferably 1 or more and 4 or less carbon atoms, more preferably 1 or more and 2 or less carbon atoms, still more preferably 1 carbon atom). That is, the poly(meth)acrylate compound (B) may be a poly(alkyl (meth)acrylate) having an alkyl chain with 1 or more and 8 or less carbon atoms (preferably 1 or more and 4 or less carbon atoms, more preferably 1 or more and 2 or less carbon atoms, still more preferably 1 carbon atom). The poly(alkyl (meth)acrylate) having an alkyl chain with 1 carbon atom may be poly(methyl methacrylate).

Examples of the monomer other than (meth)acrylate in the poly(meth)acrylate compound (B) include

styrenes [e.g., monomers having styrene skeletons, such as styrene, alkylated styrenes (e.g., α-methylstyrene, 2-methylstyrene, 3-methylstyrene, 4-methylstyrene, 2-ethylstyrene, 3-ethylstyrene, 4-ethylstyrene), halogenated styrenes (e.g., 2-chlorostyrene, 3-chlorostyrene, 4-chlorostyrene), vinylnaphthalenes (e.g., 2-vinylnaphthalene), and hydroxystyrenes (e.g., 4-ethenylphenol)],

acrylonitriles [monomers having acrylonitrile backbones, such as methylacrylonitrile, ethylacrylonitrile, and phenylacrylonitrile], and

vinyl alcohols [monomers having vinyl alcohol skeletons, such as vinyl alcohol and methyl vinyl alcohol].

The weight-average molecular weight (Mw) of the poly(meth)acrylate compound (B) is not limited, but may be 27,000 or more and 120,000 or less (preferably more than 30,000 and 100,000 or less, more preferably 30,100 or more and 100,000 or less, and still more preferably 30,500 or more and 100,000 or less).

The weight-average molecular weight (Mw) of the poly(meth)acrylate compound (B) is preferably less than 50,000, more preferably 45,000 or less, and still more preferably 30,000 or less in order particularly to suppress a decrease in the transparency of the obtained resin molded body and maintain the tensile yield strength in a high-humidity/high-temperature environment. The weight-average molecular weight (Mw) of the poly(meth)acrylate compound (B) may be 27,000 or more.

The weight-average molecular weight (Mw) of the poly(meth)acrylate compound (B) is a value determined by gel permeation chromatography (GPC). Specifically, the determination of the molecular weight by GPC is carried out using HLC-8320GPC available from Tosoh Corporation as a measurement system and using column TSKgel α-M available from Tosoh Corporation and a tetrahydrofuran solvent. The weight-average molecular weight (Mw) is calculated from the molecular weight calibration curve created on the basis of the obtained measurement results using a monodisperse polystyrene standard.

Poly(meth)acrylate Compound (C) with Reactive Group that Reacts with Hydroxyl Group of Cellulose Ester Compound (A): Component (C)

The poly(meth)acrylate compound (C) according to the exemplary embodiment is a compound (resin) having a reactive group that reacts with a hydroxyl group of the cellulose ester compound (A) and having a structural unit derived from (meth) acrylate.

The poly(meth)acrylate compound (C) may be a compound (resin) having a structural unit derived from a monomer other than (meth)acrylate as long as the poly(meth)acrylate compound (C) is a compound (resin) having a reactive group that reacts with a hydroxyl group of the cellulose ester compound (A). The poly(meth)acrylate compound (C) may have one structural unit (monomer-derived unit) or two or more structural units.

Examples of the reactive group (hereinafter may be referred to as a “reactive group”) that reacts with a hydroxyl group of the cellulose ester compound (A) include a glycidyl group, a dicarboxylic anhydride group, a carboxy group, an oxazoline group, an isocyanate group, and a hydroxyl group.

Among these groups, the poly(meth)acrylate compound (C) preferably has at least one group selected from a glycidyl group, a dicarboxylic anhydride group, and a carboxy group as the “reactive group that reacts with a hydroxyl group of the cellulose ester compound (A)” in order to suppress a decrease in the transparency of the obtained resin molded body and maintain the tensile yield strength in a high-humidity/high-temperature environment. The compound may be used alone or in combination of two or more.

Examples of the monomer that introduces a glycidyl group into the poly(meth)acrylate compound (C) include glycidyl group-containing vinyl compounds.

Examples of the monomer that introduces a dicarboxylic anhydride group into the poly(meth)acrylate compound (C) include unsaturated dicarboxylic anhydrides.

Examples of the monomer that introduces a carboxy group into the poly(meth)acrylate compound (C) include (meth)acrylic acid.

In other words, the poly(meth)acrylate compound (C) may be a polymer of at least one selected from glycidyl group-containing vinyl compounds, unsaturated dicarboxylic anhydrides, and (meth)acrylic acid in order to suppress a decrease in the transparency of the obtained resin molded body and maintain the tensile yield strength in a high-humidity/high-temperature environment.

Examples of glycidyl group-containing vinyl compounds include, but are not limited to, glycidyl (meth)acrylate, glycidyl itaconate, diglycidyl itaconate, allyl glycidyl ether, styrene-4-glycidyl ether, and 4-glycidylstyrene. Among these compounds, glycidyl (meth)acrylate is preferred in order to suppress a decrease in the transparency of the obtained resin molded body and maintain the tensile yield strength in a high-humidity/high-temperature environment. These compounds may be used alone or in combination of two or more.

Examples of unsaturated dicarboxylic anhydrides include, but are not limited to, maleic anhydride, itaconic anhydride, glutaconic anhydride, citraconic anhydride, and aconitic anhydride. Among these anhydrides, maleic anhydride is preferred in order to suppress a decrease in the transparency of the obtained resin molded body and maintain the tensile yield strength in a high-humidity/high-temperature environment. These anhydrides may be used alone or in combination of two or more.

The poly(meth)acrylate compound (C) may be a copolymer formed by copolymerization of at least one monomer selected from glycidyl group-containing vinyl compounds, unsaturated dicarboxylic anhydrides, and (meth)acrylic acid, and other monomer without the reactive group.

Examples of other monomer without the reactive group include alkyl (meth)acrylates and styrenes.

Examples of other alkyl (meth)acrylates without the reactive group include methyl (meth)acrylate, ethyl (meth)acrylate, n-propyl (meth)acrylate, isopropyl (meth)acrylate, n-butyl (meth)acrylate, isobutyl (meth) acrylate, tert-butyl (meth) acrylate, n-hexyl (meth) acrylate, cyclohexyl (meth) acrylate, 2-ethylhexyl (meth)acrylate, n-octyl (meth)acrylate, isooctyl (meth) acrylate, 2-ethyloctyl (meth) acrylate, dodecyl (meth)acrylate, isodecyl (meth)acrylate, lauryl (meth)acrylate, stearyl (meth)acrylate, various aryl (meth)acrylates (e.g., benzyl (meth)acrylate, phenyl (meth)acrylate, phenoxyethyl (meth)acrylate), various alkyl carbitol (meth)acrylates (e.g., ethyl carbitol (meth)acrylate), and various (meth)acrylates (e.g., isobornyl (meth) acrylate, dicyclopentanyl (meth) acrylate, dicyclopentenyl (meth) acrylate, dicyclopentenyloxy ethyl (meth)acrylate, and tetrahydrofurfuryl (meth)acrylate).

Examples of other styrenes without the reactive group include monomers having styrene skeletons, such styrene, alkylated styrenes (e.g., α-methylstyrene, 2-methylstyrene, 3-methylstyrene, 4-methylstyrene, 2-ethylstyrene, 3-ethylstyrene, 4-ethylstyrene), halogenated styrenes (e.g., 2-chlorostyrene, 3-chlorostyrene, 4-chlorostyrene), vinylnaphthalenes (e.g., 2-vinylnaphthalene), and hydroxystyrenes (e.g., 4-ethenylphenol).

Examples of commercially available copolymers include, but are not limited to, “Marproof G-01100 available—from NOF Corporation”, “Marproof G-0150M available from NOF Corporation”, “Marproof G-2050M available from NOF Corporation”, “Marproof G-017581 available from NOF Corporation”, “Marproof G available from NOF Corporation”, and “Delpet 980N available from Asahi-Kasei Chemicals Corporation.

The poly(meth)acrylate compound (C) may be a copolymer of a polysiloxane, an alkyl (meth)acrylate, and a hydroxyalkyl (meth)acrylate. The polysiloxane is not limited as long as having a “—Si—O—Si—” structure as a minimum structural unit. Examples of the polysiloxane include polydimethylsiloxane and polymethylphenylsiloxane.

Examples of commercially available polymers having a polysiloxane include “Chaline R-170 available from Nissin Chemical Industry Co., Ltd.” and “Chaline R-170S available from Nissin Chemical Industry Co., Ltd.”

The weight-average molecular weight (Mw) of the poly(meth)acrylate compound (C) is not limited, but may be 27,000 or more and 120,000 or less (preferably more than 30,000 and 100,000 or less, more preferably 30,100 or more and 100,000 or less, and still more preferably 30,500 or more and 100,000 or less).

The weight-average molecular weight (Mw) of the poly(meth)acrylate compound (C) is preferably less than 50,000, more preferably 45,000 or less, and still more preferably 30,000 or less in order particularly to suppress a decrease in the transparency of the obtained resin molded body and maintain the tensile yield strength in a high-humidity/high-temperature environment. The weight-average molecular weight (Mw) of the poly(meth)acrylate compound (C) may be 27,000 or more.

The weight-average molecular weight (Mw) of the poly(meth)acrylate compound (C) is a value determined by gel permeation chromatography (GPC). Specifically, the determination of the molecular weight by GPC is carried out using HLC-8320GPC available from Tosoh Corporation as a measurement system and using column TSKgel α-M available from Tosoh Corporation and a tetrahydrofuran solvent. The weight-average molecular weight (Mw) is calculated from the molecular weight calibration curve created on the basis of the obtained measurement results using a monodisperse polystyrene standard.

Amount or Mass Ratio for Components (A) to (C)

The amount or the mass ratio of each component will be described. The amount or the mass ratio of each component may be in the following range in order to suppress a decrease in the transparency of the obtained resin molded body and improve impact resistance. The shortened name for each component is as described below.

Component (A)=the cellulose ester compound (A) Component (B)=the poly(meth)acrylate compound (B) without a reactive group that reacts with a hydroxyl group of the cellulose ester compound (A)

Component (C)=the poly(meth)acrylate compound (C) with a reactive group that reacts with a hydroxyl group of the cellulose ester compound (A)

The amount of the component (A) relative to the resin composition is preferably 50 mass % or more, more preferably 60 mass % or more, and still more preferably 70 mass % or more in order to suppress a decrease in the transparency of the obtained resin molded body and maintain the tensile yield strength in a high-humidity/high-temperature environment.

When the amount of the cellulose ester compound (A) relative to the resin composition is 50% or more, a decrease in the transparency of the obtained resin molded body tends to be suppressed, and the tensile yield strength tends to be maintained in a high-humidity/high-temperature environment compared with the case where the amount of the cellulose ester compound (A) is less than 50%.

The ratio [(A)/((A)+(B)+(C))] of the mass of the component (A) to the total mass of the component (A), the component (B), and the component (C) is preferably 0.4 or more and 0.95 or less, more preferably 0.45 or more and 0.9 or less, and still more preferably 0.55 or more and 0.8 or less.

When the ratio of the mass of the component (A) to the total mass of the component (A), the component (B), and the component (C) is 0.45 or more and 0.9 or less, a decrease in the transparency of the obtained resin molded body tends to be suppressed, and the tensile yield strength tends to be maintained in a high-humidity/high-temperature environment.

The ratio [(B)/((A)+(B)+(C))] of the mass of the component (B) to the total mass of the component (A), the component (B), and the component (C) is preferably 0.02 or more and 0.5 or less, more preferably 0.05 or more and 0.5 or less, and still more preferably 0.05 or more and 0.3 or less.

When the ratio of the mass of the component (B) to the total mass of the component (A), the component (B), and the component (C) is 0.02 or more and 0.5 or less, a decrease in the transparency of the obtained resin molded body tends to be suppressed, and the tensile yield strength tends to be maintained in a high-humidity/high-temperature environment.

The ratio [(C)/((A)+(B)+(C))] of the mass of the component (C) to the total mass of the component (A), the component (B), and the component (C) is preferably 0.02 or more and 0.3 or less, more preferably 0.02 or more and 0.12 or less, and still more preferably 0.05 or more and 0.12 or less.

When the ratio of the mass of the component (C) to the total mass of the component (A), the component (B), and the component (C) is 0.02 or more and 0.3 or less, a decrease in the transparency of the obtained resin molded body tends to be suppressed, and the tensile yield strength tends to be maintained in a high-humidity/high-temperature environment.

### Polyester Resin (D): Component (D)

The resin composition according to the exemplary embodiment may contain a polyester resin (D).

Examples of the polyester resin (D) include polymers of hydroxyalkanoates (hydroxyalkanoic acids), polycondensates of polycarboxylic acids and polyalcohols, and ring-opened polycondensates of cyclic lactams.

The polyester resin (D) may be an aliphatic polyester resin. Examples of the aliphatic polyester include polyhydroxyalkanoates (polymers of hydroxyalkanoates) and polycondensates of aliphatic diols and aliphatic carboxylic acids.

Among these aliphatic polyesters, a polyhydroxyalkanoate is preferred as the polyester resin (D) in order to suppress a decrease in the transparency of the obtained resin molded body and maintain the tensile yield strength in a high-humidity/high-temperature environment.

Examples of the polyhydroxyalkanoate include a compound having a structural unit represented by general formula (PHA).

The compound having a structural unit represented by general formula (PHA) may include a carboxyl group at each terminal of the polymer chain (each terminal of the main chain) or may include a carboxyl group at one terminal and a different group (e.g., hydroxyl group) at the other terminal.

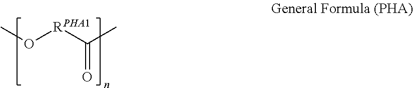

In general formula (PHA), R^{PHA1} represents an alkylene group having 1 or more and 10 or less carbon atoms, and n represents an integer of 2 or more.

In general formula (PHA), the alkylene group represented by R^{PHA1} may be an alkylene group having 3 or more and 6 or less carbon atoms. The alkylene group represented by R^{PHA1} may be a linear alkylene group or a branched alkylene group, and is preferably a branched alkylene group.

The expression “R^{PHA1} in general formula (PHA) represents an alkylene group” indicates 1) having a [O—R^{PHA1}—C(═O)—] structure where R^{PHA1} represents the same alkylene group, or 2) having plural [O—R^{PHA1}—C(═O)—] structures where R^{PHA1} represents different alkylene groups (R^{PHA1} represents alkylene groups different from each other in branching or the number of carbon atoms (e.g., a [O—R^{PHA1A}—C(═O)—] [O—R^{PHA1B}— C(═O)—] structure).

In other words, the polyhydroxyalkanoate may be a homopolymer of one hydroxyalkanoate (hydroxyalkanoic acid) or may be a copolymer of two or more hydroxyalkanoates (hydroxyalkanoic acids).

In general formula (PHA), the upper limit of n is not limited, and n is, for example, 20,000 or less. For the range of n, n is preferably 500 or more and 10,000 or less, and more preferably 1,000 or more and 8,000 or less.

Examples of the polyhydroxyalkanoate include homopolymers of hydroxyalkanoic acids (e.g., lactic acid, 2-hydroxybutyric acid, 3-hydroxybutyric acid, 4-hydroxybutyric acid, 2-hydroxy-3-methylbutyric acid, 2-hydroxy-3,3-dimethylbutyric acid, 3-hydroxyvaleric acid, 4-hydroxyvaleric acid, 5-hydroxyvaleric acid, 3-hydroxyhexanoic acid, 2-hydroxyhexanoic acid, 2-hydroxyisohexanoic acid, 6-hydroxyhexanoic acid, 3-hydroxypropionic acid, 3-hydroxy-2,2-dimethylpropionic acid, and 3-hydroxyhexanoic acid, 2-hydroxy-n-octanoic acid), and copolymers of two or more of these hydroxyalkanoic acids.

Among these, the polyhydroxyalkanoate is preferably a homopolymer of a branched hydroxyalkanoic acid having 2 or more and 4 or less carbon atoms, or a homocopolymer of a branched hydroxyalkanoic acid having 2 or more and 4 or less carbon atoms and a branched hydroxyalkanoic acid having 5 or more and 7 or less carbon atoms, more preferably a homopolymer of a branched hydroxyalkanoic acid having 3 carbon atoms (i.e., polylactic acid), or a homocopolymer of 3-hydroxybutyric acid and 3-hydroxyhexanoic acid (i.e., polyhydroxybutyrate-hexanoate), and still more preferably a homopolymer of a branched hydroxyalkanoic acid having 3 carbon atoms, that is, polylactic acid in order to suppress a decrease in the transparency of the obtained resin molded body and maintain the tensile yield strength in a high-humidity/high-temperature environment.

The number of carbon atoms in hydroxyalkanoic acid is a number inclusive of the number of the carbon of the carboxyl group.

In polyhydroxybutyrate-hexanoate, the copolymerization ratio of 3-hydroxyhexanoic acid (3-hydroxyhexanoate) to a copolymer of 3-hydroxybutyric acid (3-hydroxybutyrate) and 3-hydroxyhexanoic acid (3-hydroxyhexanoate) is preferably 3 mol % or more and 20 mol % or less, more preferably 4 mol % or more and 15 mol % or less, and still more preferably 5 mol % or more and 12 mol % or less in order to suppress a decrease in the transparency of the obtained resin molded body and maintain the tensile yield strength in a high-humidity/high-temperature environment.

The copolymerization ratio of 3-hydroxyhexanoic acid (3-hydroxyhexanoate) is determined using H¹-NMR such that the ratio of the hexanoate is calculated from the integrated values of the peaks from the hexanoate terminal and the butyrate terminal.

Polylactic acid is a polymer compound formed by polymerization of lactic acid through ester bonding.

Examples of polylactic acid include a homopolymer of L-lactic acid, a homopolymer of D-lactic acid, a block copolymer including a polymer of at least one of L-lactic acid and D-lactic acid, and a graft copolymer including a polymer of at least one of L-lactic acid and D-lactic acid.

Examples of a “compound copolymerizable with L-lactic acid or D-lactic acid” include glycolic acid, dimethyl glycolic acid, 3-hydroxybutyric acid, 4-hydroxybutyric acid, 2-hydroxypropanoic acid, 3-hydroxypropanoic acid, 2-hydroxyvaleric acid, 3-hydroxyvaleric acid, and 4-hydroxyvaleric acid; polycarboxylic acids, such as oxalic acid, malonic acid, succinic acid, glutaric acid, adipic acid, pimelic acid, azelaic acid, sebacic acid, undecanedioic acid, dodecanedioic acid, and terephthalic acid, and anhydrides thereof; polyhydric alcohols, such as ethyleneglycol, diethyleneglycol, triethyleneglycol, 1,2-propanediol, 1,3-propanediol, 1,3-butanediol, 1,4-butanediol, 2,3-butanediol, 1,5-pentanediol, 1,6-hexanediol, 1,9-nonanediol, 3-methyl-1,5-pentanediol, neopentylglycol, tetramethyleneglycol, and 1,4-hexanedimethanol; polysaccharides, such as cellulose; aminocarboxylic acids, such as α-amino acid; hydroxycarboxylic acids, such as 5-hydroxyvaleric acid, 2-hydroxycaproic acid, 3-hydroxycaproic acid, 4-hydroxycaproic acid, 5-hydroxycaproic acid, 6-hydroxycaproic acid, 6-hydroxymethylcaproic acid, and mandelic acid; and cyclic esters, such as glycolide, β-methyl-δ-valerolactone, γ-valerolactone, and ε-caprolactone.

Polylactic acid is known to be produced by: a lactide method via lactide; a direct polymerization method involving heating lactic acid in a solvent under a reduced pressure to polymerize lactic acid while removing water; or other methods.

Examples of a “copolymer of L-lactic acid or D-lactic acid and a compound copolymerizable with L-lactic acid or D-lactic acid” include a block copolymer or graft copolymer having a polylactic acid sequence capable of generating a helical crystal.

A polylactic acid-based polymer can be produced by: for example, methods involving direct dehydration condensation of lactic acid as described in Japanese Unexamined Patent Application Publication Nos. 59-096123 and 7-033861; methods involving ring-opening polymerization using lactide, which is a cyclic dimer of lactic acid, as described in U.S. Pat. Nos. 2,668,182 and 4,057,357; or other methods.

To achieve an optical purity of 95.00% ee or more for the polylactic acid-based polymer produced by any of the above-described production methods, lactide whose optical purity has been increased to 95.00% ee or more by a crystallization procedure may be polymerized when polylactic acid is produced by, for example, a lactide method.

The weight-average molecular weight (Mw) of the polyester resin (D) may be 10,000 or more and 1,000,000 or less (preferably 50,000 or more and 800,000 or less, more preferably 100,000 or more and 600,000 or less) in order to suppress a decrease in the transparency of the obtained resin molded body and maintain the tensile yield strength in a high-humidity/high-temperature environment.

The weight-average molecular weight (Mw) of the polyester resin (D) is a value determined by gel permeation chromatography (GPC). Specifically, the determination of the molecular weight by GPC is carried out using HLC-8320GPC available from Tosoh Corporation as a measurement system, columns TSKgel GMHHR-M+TSKgel GMHHR-M (7.8 mm I.D., 30 cm) available from Tosoh Corporation, and a chloroform solvent. The weight-average molecular weight (Mw) is calculated from the molecular weight calibration curve created on the basis of the obtained measurement results using a monodisperse polystyrene standard.

The amount of the polyester resin (D) relative to the resin composition is preferably 2 mass % or more and 30 mass % or less, and more preferably 5 mass % or more and 20 mass % or less in order to suppress a decrease in the transparency of the obtained resin molded body and maintain the tensile yield strength in a high-humidity/high-temperature environment.

Other Components

The resin composition according to the exemplary embodiment may contain a thermoplastic elastomer.

Thermoplastic elastomer is, for example, an elastomer that has rubber properties at room temperature (25° C.) and softens at high temperature like thermoplastic resin. Examples of thermoplastic elastomers include (meth)acrylic thermoplastic elastomers and styrenic thermoplastic elastomers.

Examples of (meth)acrylic thermoplastic elastomers include a polymer of two or more alkyl (meth)acrylates and a polymer of an olefin and an alkyl (meth)acrylate. Specific examples include a poly(methyl methacrylate)-poly(n-butyl acrylate)-poly(methyl methacrylate) block copolymer, a poly(methyl methacrylate)-poly(dodecyl methacrylate)-poly(methyl methacrylate) block copolymer, a poly(methyl methacrylate)-poly(2-ethylhexyl methacrylate)-poly(methyl methacrylate) block copolymer, a poly(methyl methacrylate)-poly(lauryl methacrylate)-poly(methyl methacrylate) block copolymer, and an ethylene-methyl acrylate block copolymer.

Examples of styrenic thermoplastic elastomers include a copolymer of a styrene (a monomer having a styrene skeleton) and an olefin, a copolymer of a styrene and a conjugated diene, and a copolymer of a styrene, a conjugated diene, and an olefin. Specific examples include a polystyrene-polybutadiene-polystyrene block copolymer, a polystyrene-polybutadiene-polybutylene-polystyrene block copolymer, a polystyrene-polyethylene-polybutylene-polystyrene block copolymer, a polystyrene-polyisoprene-polystyrene block copolymer, a polystyrene-hydrogenated polybutadiene-polystyrene block copolymer, a polystyrene-hydrogenated polyisoprene-polystyrene block copolymer, and a polystyrene-polyisoprene-hydrogenated butadiene-polystyrene block copolymer.

The amount of the thermoplastic elastomer may be 0.5 mass % or more and 5 mass % or less relative to the resin composition.

Components Other than Thermoplastic Elastomer

The resin composition according to the exemplary embodiment may contain components other than the above-described thermoplastic elastomer. Examples of other components include a flame retardant, a compatibilizer, an antioxidant, a release agent, a light resisting agent, a weathering agent, a colorant, a pigment, a modifier, an anti-drip agent, an antistatic agent, a hydrolysis inhibitor, a filler, and reinforcing agents (e.g., glass fiber, carbon fiber, talc, clay, mica, glass flake, milled glass, glass beads, crystalline silica, alumina, silicon nitride, aluminum nitride, and boron nitride).

As needed, components (additives), such as a reactive trapping agent and an acid acceptor for avoiding release of acetic acid, may be added. Examples of the acid acceptor include oxides, such as magnesium oxide and aluminum oxide; metal hydroxides, such as magnesium hydroxide, calcium hydroxide, aluminum hydroxide, and hydrotalcite; calcium carbonate; and talc.

Examples of the reactive trapping agent include epoxy compounds, acid anhydride compounds, and carbodiimides.

The amount of each of these components may be 0 mass % or more and 5 mass % or less relative to the total amount of the resin composition. The expression “0 mass %” means that the resin composition is free of a corresponding one of other components.

The resin composition according to the exemplary embodiment may contain resins other than the above-described resins (the cellulose ester compound (A), the poly(meth)acrylate compound (B) without a reactive group that reacts with a hydroxyl group of the cellulose ester compound (A), the poly(meth)acrylate compound (C) with a reactive group that reacts with a hydroxyl group of the cellulose ester compound (A), and the polyester resin (D)). When other resins are present, the amount of other resins relative to the total amount of the resin composition is 5 mass % or less, and preferably less than 1 mass %. More preferably, the resin composition is free of other resins (i.e., 0 mass %).

Examples of other resins include thermoplastic resins known in the art. Specific examples include polycarbonate resin; polypropylene resin; polyester resin; polyolefin resin; polyester-carbonate resin; polyphenylene ether resin; polyphenylene sulfide resin; polysulfone resin; polyether sulfone resin; polyarylene resin; polyetherimide resin; polyacetal resin; polyvinyl acetal resin; polyketone resin; polyether ketone resin; polyether ether ketone resin; polyaryl ketone resin; polyether nitrile resin; liquid crystal resin; polybenzimidazole resin; polyparabanic acid resin; a vinyl polymer or a vinyl copolymer produced by polymerizing or copolymerizing at least one vinyl monomer selected from the group consisting of an aromatic alkenyl compound, a methacrylic acid ester, an acrylic acid ester, and a vinyl cyanide compound; a diene-aromatic alkenyl compound copolymer; a vinyl cyanide-diene-aromatic alkenyl compound copolymer; an aromatic alkenyl compound-diene-vinyl cyanide-N-phenylmaleimide copolymer; a vinyl cyanide-(ethylene-diene-propylene (EPDM))-aromatic alkenyl compound copolymer; polyvinyl chloride resin; and chlorinated polyvinyl chloride resin. These resins may be used alone or in combination of two or more.

Method for Producing Resin Composition

A method for producing the resin composition according to the exemplary embodiment includes, for example, preparing a resin composition containing the cellulose ester compound (A), the poly(meth)acrylate compound (B) without a reactive group that reacts with a hydroxyl group of the cellulose ester compound (A), and the poly(meth)acrylate compound (C) with a reactive group that reacts with a hydroxyl group of the cellulose ester compound (A).

The resin composition according to the exemplary embodiment is produced by melt-kneading a mixture containing the cellulose ester compound (A), the poly(meth)acrylate compound (B) without a reactive group that reacts with a hydroxyl group of the cellulose ester compound (A), the poly(meth)acrylate compound (C) with a reactive group that reacts with a hydroxyl group of the cellulose ester compound (A), and as needed, other components. Alternatively, the resin composition according to the exemplary embodiment is also produced by, for example, dissolving the above-described components in a solvent.

An apparatus used for melt kneading is, for example, a known apparatus. Specific examples of the apparatus include a twin screw extruder, a Henschel mixer, a Banbury mixer, a single screw extruder, a multi-screw extruder, and a co-kneader.

### Resin Molded Body

A resin molded body according to an exemplary embodiment contains the resin composition according to the exemplary embodiment. In other words, a resin molded body according to an exemplary embodiment has the same composition as the resin composition according to the exemplary embodiment.

The method for molding the resin molded body according to the exemplary embodiment may be injection molding in terms of a high degree of freedom in shaping. For this point, the resin molded body may be an injection-molded body formed by injection molding.

The cylinder temperature during injection molding is, for example, 160° C. or higher and 280° C. or lower, and preferably 180° C. or higher and 260° C. or lower. The mold temperature during injection molding is, for example, 40° C. or higher and 90° C. or lower, and preferably 60° C. or higher and 80° C. or lower.

Injection molding may be performed using a commercially available apparatus, such as NEX 500 available from Nissei Plastic Industrial Co., Ltd., NEX 150 available from Nissei Plastic Industrial Co., Ltd., NEX 70000 available from Nissei Plastic Industrial Co., Ltd., PNX 40 available from Nissei Plastic Industrial Co., Ltd., and SE50D available from Sumitomo Heavy Industries.

The molding method for producing the resin molded body according to the exemplary embodiment is not limited to injection molding described above. Examples of the molding method include extrusion molding, blow molding, heat press molding, calendar molding, coating molding, cast molding, dipping molding, vacuum molding, and transfer molding.

The resin molded body according to the exemplary embodiment may have a haze value of 10% or lower (preferably 8% or lower) when having a thickness of 2 mm. When the resin molded body having a thickness of 2 mm has a haze value of 10% or lower, the resin molded body is said to have transparency. The haze value of the resin molded body is ideally 0%, but may be 0.5% or higher from a manufacturing viewpoint. The haze value of the resin molded body is determined by the method described in Examples.

The resin molded body according to the exemplary embodiment is used in various applications, such as electrical and electronic devices, office machines, home appliances, automotive interior materials, toys, and containers. More specifically, the resin molded body is used in housings of electrical and electronic devices and home appliances; various parts of electrical and electronic devices and home appliances; automotive interior parts; block assembly toys; plastic model kits; cases for CD-ROMs, DVDs, and the like; tableware; drink bottles; food trays; wrapping materials; films; and sheets.

### Examples

The present invention will be described below in more detail by way of Examples, but the present invention is not limited by these Examples. The unit “part(s)” refers to “part(s) by mass” unless otherwise specified.

### Preparation of Materials

The following materials are prepared.

### Preparation of Cellulose Ester Compound (A)

CAP1: cellulose acetate propionate

(CAP482-20 available from Eastman Chemical Company)
CAP2: cellulose acetate propionate

(CAP482-0.5 available from Eastman Chemical Company)
CAP3: cellulose acetate propionate

(CAP482-0.2 available from Eastman Chemical Company)
CAB1: cellulose acetate butylate

(CAB500-5 available from Eastman Chemical Company)
CAB2: cellulose acetate butylate

(CAB500-20 available from Eastman Chemical Company)
CAB3: cellulose acetate butylate

(CAB500-15 available from Eastman Chemical Company)
DAC1: cellulose acylate

(L50 available from Daicel Corporation)

### Preparation of Poly(meth)acrylate Compound (B)

PMMA1: polymethyl methacrylate (weight-average molecular weight=25,000)

(Delpowder 500V available from Asahi Kasei Chemicals Corporation)
PMMA2: polymethyl methacrylate (weight-average molecular weight=55,000)

(Delpet 720V available from Asahi Kasei Chemicals Corporation)
PMMA3: polymethyl methacrylate (weight-average molecular weight=48,000)

(Delpowder 720V available from Asahi Kasei Chemicals Corporation)
PMMA4: polymethyl methacrylate (weight-average molecular weight=95,000)

(Sumipex MHF available from Sumitomo Chemical Co., Ltd.)

### Preparation of Poly(meth)acrylate Compound (C)

GMA1: copolymer of glycidyl methacrylate and methyl methacrylate

(Metablen P-1900 available from Mitsubishi Rayon Co., Ltd. (Mitsubishi Chemical Corporation))
GMA2: homopolymer of glycidyl methacrylate

(weight-average molecular weight=12,000)

(Marproof G-01100 available from NOF Corporation)
GMA3: copolymer of glycidyl methacrylate and methyl methacrylate

(weight-average molecular weight=10,000)

(Marproof G-0150M available from NOF Corporation)
GMA4: copolymer of glycidyl methacrylate and methyl methacrylate

(weight-average molecular weight=200,000 to 250,000)

(Marproof G-2050M available from NOF Corporation)
GMA5: copolymer of glycidyl methacrylate and an alkyl methacrylate mixture

(weight-average molecular weight=10,000)

(Marproof G-017581 available from NOF Corporation)
GMA6: copolymer of glycidyl methacrylate and 2-ethyl-hexyl methacrylate

(weight-average molecular weight=45,000)

(Prototype)
MAI-11: copolymer of maleic anhydride, methyl methacrylate, and styrene

(weight-average molecular weight=50,000 to 70,000)

(Delpet 980N available from Asahi Kasei Chemicals Corporation)
SIL1: copolymer of poly(alkyl siloxane), alkyl methacrylate, and hydroxyalkyl methacrylate

(weight-average molecular weight=80,000 to 100,000)

(Chaline R-170 available from Nissin Chemical Industry Co., Ltd.)

### Preparation of Polyester Resin (D)

PLA1: polylactic acid

(Ingio 3001D available from NatureWorks LLC)
PLA2: polylactic acid

(Lacea H100 available from Mitsui Chemicals, Inc.)
PHBH1: copolymer of R-3-hydroxybutyric acid and R-3-hydroxyhexanoic acid

(Aonilex X151 available from Kaneka Corporation)

### Examples 1 to 37 and Comparative Examples 1 to 8

### Kneading and Injection Molding

A resin composition (pellets) is produced by performing kneading with a twin screw kneader (LTE20-44 available from Labtech Engineering) at the preparation composition ratio shown in Tables 1 and 2, and the kneading temperature and the molding temperature shown in Tables 1 and 2.

The produced pellets are molded into the following resin molded bodies (1) and (2) using an injection molding machine (NEX 5001 available from Nissei Plastic Industrial Co., Ltd.) at an injection peak pressure of less than 180 MPa, the cylinder temperature shown in Tables 1 and 2, and a mold temperature of 60° C.
(1): D2 test piece (size: 60 mm×60 mm, 2 mm thick)
(2): ISO multi-purpose dumbbell (measurement part: 10 mm wide×4 mm thick)

### Evaluation

The molded bodies produced in Examples 1 to 37 and Comparative Examples 1 to 8 are subjected to the following evaluation. The evaluation results are shown in Tables 1 and 2.

### Haze Value

The haze value is measured for each D2 test piece using a haze meter (SH-7000 available from Nippon Denshoku Industries Co., Ltd.).

### Total Light Transmittance (%)

The total light transmittance at a wavelength of 530 nm is measured for each D2 test piece using a spectral haze meter (SH 7000 available from Nippon Denshoku Industries Co., Ltd).

### Tensile Yield Strength (MPa)

The ISO multi-purpose dumbbells of Examples 1 to 37 and Comparative Examples 1 to 8 are exposed to the conditions of 65° C. and 90% RH in a constant temperature and humidity chamber (ARS-0680) available from Espec Corporation), and the tensile yield strength is measured before exposure, 500 hours after exposure, and 3000 hours after exposure by a method in conformity with ISO527 using a universal tester “autograph AG-Xplus available from Shimadzu Corporation”.

TABLE 1

| | | | | | | | | | Production | | Evaluation | | | | |
|---|---|---|---|---|---|---|---|---|---|---|---|---|---|---|---|
| | | Type and number of parts by | | | | Mass ratio of components | | | Cylinder | Cylinder | | | Tensile yield strength | | |
| | | mass of components in resin composition | | | | in resin composition | | | temperature | temperature | Total light | Haze | (MPa) | | |
| | | Cellulose ester | Poly(meth)acrylate | Poly(meth)acrylate | Polyester | (A)/ | (B)/ | (C)/ | (° C.) during | (° C.) during | transmittance | value | | after | after |
| Run no. | | compound (A) | compound (B) | compound (C) | resin (D) | (A + B + C) | (A + B + C) | (A + B + C) | kneading | molding | (%) | (%) | 0 hrs | 500 hrs | 3000 hrs |
| Example | 1 | CAP1 = 100 | PMMA1 = 10 | GMA1 = 10 | — | 0.83 | 0.083 | 0.083 | 200 | 200 | 93 | 6 | 60 | 59 | 59 |
| | 2 | CAP2 = 100 | PMMA1 = 10 | GMA1 = 10 | — | 0.83 | 0.083 | 0.083 | 200 | 200 | 92 | 6 | 60 | 60 | 60 |
| | 3 | CAP3 = 100 | PMMA1 = 10 | GMA1 = 10 | — | 0.83 | 0.083 | 0.083 | 200 | 200 | 92 | 5 | 60 | 60 | 60 |
| | 4 | CAB1 = 100 | PMMA1 = 10 | GMA1 = 10 | — | 0.83 | 0.083 | 0.083 | 200 | 200 | 92 | 6 | 57 | 57 | 57 |
| | 5 | CAB2 = 100 | PMMA1 = 10 | GMA1 = 10 | — | 0.83 | 0.083 | 0.083 | 200 | 200 | 92 | 6 | 57 | 57 | 57 |
| | 6 | CAB3 = 100 | PMMA1 = 10 | GMA1 = 10 | — | 0.83 | 0.083 | 0.083 | 200 | 200 | 92 | 5 | 57 | 57 | 57 |
| | 7 | DAC1 = 100 | PMMA1 = 10 | GMA1 = 10 | — | 0.83 | 0.083 | 0.083 | 240 | 250 | 90 | 8 | 80 | 78 | 74 |
| | 8 | CAP1/CAB1 = | PMMA1 = 10 | GMA1 = 10 | — | 0.83 | 0.083 | 0.083 | 190 | 200 | 93 | 6 | 58 | 58 | 58 |
| | | 80/20 | | | | | | | | | | | | | |
| | 9 | CAP1/CAB1 = | PMMA1 = 10 | GMA1 = 10 | — | 0.83 | 0.083 | 0.083 | 190 | 200 | 93 | 6 | 58 | 58 | 58 |
| | | 50/50 | | | | | | | | | | | | | |
| | 10 | CAP1/CAB1 = | PMMA1 = 10 | GMA1 = 10 | — | 0.83 | 0.083 | 0.083 | 190 | 200 | 93 | 5 | 58 | 58 | 58 |
| | | 20/80 | | | | | | | | | | | | | |
| | 11 | CAP1 = 100 | PMMA2 = 10 | GMA1 = 10 | — | 0.83 | 0.083 | 0.083 | 200 | 200 | 90 | 8 | 60 | 59 | 56 |
| | 12 | CAP1 = 100 | PMMA3 = 10 | GMA1 = 10 | — | 0.83 | 0.083 | 0.083 | 200 | 200 | 92 | 6 | 60 | 60 | 60 |
| | 13 | CAP1 = 100 | PMMA1 = 10 | GMA2 = 10 | — | 0.83 | 0.083 | 0.083 | 200 | 200 | 92 | 5 | 60 | 60 | 60 |
| | 14 | CAP1 = 100 | PMMA1 = 10 | GMA3 = 10 | — | 0.83 | 0.083 | 0.083 | 200 | 200 | 92 | 6 | 60 | 60 | 60 |
| | 15 | CAP1 = 100 | PMMA1 = 10 | GMA4 = 10 | — | 0.83 | 0.083 | 0.083 | 200 | 200 | 92 | 6 | 58 | 58 | 58 |
| | 16 | CAP1 = 100 | PMMA1 = 10 | GMA5 = 10 | — | 0.83 | 0.083 | 0.083 | 200 | 200 | 92 | 6 | 58 | 58 | 58 |
| | 17 | CAP1 = 100 | PMMA1 = 10 | GMA6 = 10 | — | 0.83 | 0.083 | 0.083 | 200 | 200 | 91 | 8 | 59 | 57 | 55 |
| | 18 | CAP1 = 100 | PMMA1 = 10 | MAH1 = 10 | — | 0.83 | 0.083 | 0.083 | 200 | 200 | 92 | 6 | 60 | 60 | 60 |
| | 19 | CAP1 = 100 | PMMA1 = 10 | SIL1 = 10 | — | 0.83 | 0.083 | 0.083 | 200 | 200 | 90 | 8 | 50 | 48 | 46 |
| | 20 | CAP1 = 100 | PMMA1 = 10 | GMA1 = 10 | PLA1 = 10 | 0.83 | 0.083 | 0.083 | 200 | 200 | 93 | 6 | 60 | 60 | 60 |
| | 21 | CAP1 = 100 | PMMA1 = 10 | GMA1 = 10 | PLA2 = 10 | 0.83 | 0.083 | 0.083 | 200 | 200 | 92 | 6 | 60 | 60 | 60 |
| | 22 | CAP1 = 100 | PMMA1 = 10 | GMA1 = 10 | PHBH1 = 10 | 0.83 | 0.083 | 0.083 | 180 | 190 | 93 | 5 | 57 | 57 | 57 |
| | 23 | CAP1 = 100 | PMMA1 = 100 | GMA1 = 20 | — | 0.45 | 0.45 | 0.09 | 200 | 200 | 93 | 6 | 58 | 58 | 58 |
| | 24 | CAP1 = 100 | PMMA1 = 10 | GMA1 = 3 | — | 0.88 | 0.097 | 0.027 | 200 | 200 | 93 | 5 | 60 | 60 | 60 |
| | 25 | CAP1 = 100 | PMMA1 = 110 | GMA1 = 20 | — | 0.43 | 0.48 | 0.087 | 200 | 200 | 90 | 8 | 64 | 62 | 59 |
| | 26 | CAP1 = 100 | PMMA1 = 7 | GMA1 = 3 | — | 0.91 | 0.064 | 0.027 | 200 | 200 | 90 | 9 | 58 | 57 | 55 |
| | 27 | CAP1 = 100 | PMMA1 = 7 | GMA1 = 7 | — | 0.88 | 0.061 | 0.061 | 200 | 200 | 92 | 6 | 58 | 58 | 58 |
| | 28 | CAP1 = 100 | PMMA1 = 100 | GMA1 = 7 | — | 0.48 | 0.48 | 0.034 | 200 | 200 | 92 | 5 | 65 | 65 | 65 |
| | 29 | CAP1 = 100 | PMMA1 = 2 | GMA1 = 10 | | 0.89 | 0.018 | 0.089 | 200 | 200 | 90 | 8 | 58 | 57 | 55 |
| | 30 | CAP1 = 100 | PMMA1 = 110 | GMA1 = 7 | — | 0.86 | 0.51 | 0.032 | 200 | 200 | 90 | 8 | 72 | 70 | 67 |
| | 31 | CAP1 = 100 | PMMA1 = 10 | GMA1 = 2 | — | 0.89 | 0.089 | 0.018 | 200 | 200 | 90 | 9 | 59 | 58 | 56 |
| | 32 | CAP1 = 100 | PMMA1 = 10 | GMA1 = 15 | — | 0.8 | 0.08 | 0.12 | 200 | 200 | 92 | 6 | 58 | 58 | 58 |
| | 33 | CAP1 = 100 | PMMA1 = 10 | GMA1 = 50 | — | 0.63 | 0.063 | 0.31 | 200 | 200 | 90 | 9 | 56 | 55 | 52 |
| | 34 | CAP1 = 100 | PMMA1 = 15 | GMA1 = 5 | PLA1 = 15 | 0.83 | 0.13 | 0.042 | 200 | 200 | 93 | 6 | 60 | 60 | 60 |
| | 35 | CAP1 = 100 | PMMA1 = 15 | GMA1 = 5 | PLA1 = 20 | 0.83 | 0.13 | 0.042 | 200 | 200 | 93 | 5 | 60 | 60 | 60 |
| | 36 | CAP1/CAB1 = | PMMA1 = 15 | GMA1 = 5 | PLA1 = 5 | 0.83 | 0.13 | 0.042 | 190 | 190 | 93 | 5 | 58 | 58 | 58 |
| | | 50/50 | | | | | | | | | | | | | |
| | 37 | CAP1 = 100 | PMMA1 = 15 | GMA1 = 5 | PLA1 = 30 | 0.83 | 0.13 | 0.042 | 190 | 190 | 93 | 6 | 60 | 60 | 60 |

TABLE 2

| | | Type and number of | | | | | | |
|---|---|---|---|---|---|---|---|---|
| | | parts by mass of components in resin | | | | Mass ratio of components | | |
| | | composition | | | | in resin composition | | |
| | | Cellulose ester | Poly(meth)acrylate | Poly(meth)acrylate | Polyester | (A)/ | (B)/ | (C)/ |
| Run no. | | compound (A) | compound (B) | compound (C) | resin (D) | (A + B + C) | (A + B + C) | (A + B + C) |
| Comparative | 1 | CAP1 = 100 | — | — | — | 1 | 0 | 0 |
| Example | | | | | | | | |
| | 2 | CAP1 = 100 | PMMA1 = 30 | — | — | 0.77 | 0.3 | 0 |
| | 3 | CAP1 = 20 | PMMA4 = 20 | — | PLA2 = 60 | 0.2 | 0.2 | 0 |
| | 4 | CAP1 = 80 | PMMA4 = 10 | — | PLA2 = 10 | 0.8 | 0.1 | 0 |
| | 5 | CAP1 = 40 | PMMA4 = 30 | — | PLA2 = 30 | 0.4 | 0.3 | 0 |
| | 6 | — | PMMA1 = 100 | — | — | 0 | 1 | 0 |
| | 7 | CAP1 = 100 | — | GMA1 = 10 | — | 0.91 | 0 | 0.091 |
| | 8 | — | PMMA1 = 100 | GMA1 = 10 | — | 0 | 0.91 | 0.091 |

| | | Production | | Evaluation | | | | |
|---|---|---|---|---|---|---|---|---|
| | | Cylinder | Cylinder | | | Tensile yield | | |
| | | temperature | temperature | | Haze | strength (MPa) | | |
| | | (° C.) during | (° C.) during | Total light | value | | after | after |
| Run no. | | kneading | molding | transmittance (%) | (%) | 0 hrs | 500 hrs | 3000 hrs |
| Comparative | 1 | 230 | 240 | 87 | 12 | 57 | 50 | 45 |
| Example | | | | | | | | |
| | 2 | 200 | 200 | 90 | 14 | 60 | 52 | 46 |
| | 3 | 220 | 220 | 87 | 15 | 59 | 53 | 45 |
| | 4 | 220 | 220 | 90 | 15 | 60 | 55 | 49 |
| | 5 | 220 | 220 | 88 | 14 | 60 | 52 | 43 |
| | 6 | 230 | 240 | 92 | 4 | 80 | 55 | 44 |
| | 7 | 210 | 220 | 84 | 15 | 55 | 48 | 42 |
| | 8 | 230 | 240 | 84 | 20 | 78 | 51 | 40 |

The above results indicate that the resin molded bodies according to the exemplary embodiment are resin molded bodies in which decreases in transparency are suppressed and which have a great ability to maintain their tensile yield strength in a high-humidity/high-temperature environment compared with the resin molded bodies of Comparative Examples. Specifically, there is no decrease in tensile yield strength at 65° C. and 90% RH after 500 hours and 3000 hours for the resin molded bodies of Examples 1 to 37 containing the cellulose ester compound (A), the poly(meth)acrylate compound (B) without a reactive group that reacts with a hydroxyl group of the cellulose ester compound (A), and the poly(meth)acrylate compound (C) with a reactive group that reacts with a hydroxyl group of the cellulose ester compound (A). This suggests that the resin molded bodies of Examples 1 to 37 have a great ability to maintain their tensile yield strength. In addition, the resin molded bodies of Examples 1 to 37 have a high total light transmittance and a haze value of 10% or lower. In other words, decreases in transparency are suppressed.

The tensile yield strength tends to decrease at 65° C. and 90% RH after 500 hours and 3000 hours for the resin molded bodies of Comparative Examples 1 and 7 composed of the cellulose ester compound (A), the resin molded bodies of Comparative Examples 2 and 3 composed of the cellulose ester compound (A) and the poly(meth)acrylate compound (B) without a reactive group that reacts with a hydroxyl group of the cellulose ester compound (A), and the resin molded bodies of Comparative Examples 6 and 8 composed of the poly(meth)acrylate compound (B) without a reactive group that reacts with a hydroxyl group of the cellulose ester compound (A). These resin molded bodies tend to have a lower total light transmittance and a higher haze value than the resin molded bodies containing the resin composition according to the exemplary embodiment. In other words, decreases in transparency are observed.

The resin molded bodies of Examples 20 to 22 and the resin molded bodies of Examples 34 to 37 contain the polyester resin (D) in addition to the component (A), the component (B), and the component (C). This composition suppresses decreases in transparency and eliminates decreases in tensile yield strength, which suggests that these resin molded bodies have a great ability to maintain their tensile yield strength.

When the ratio of the mass of the component (A) to the total mass of the component (A), the component (B), and the component (C) is 0.45 or more and 0.9 or less as in the resin molded bodies of Examples 1 to 7, resin molded bodies in which decreases in transparency are suppressed and which have a great ability to maintain their tensile yield strength in a high-humidity/high-temperature environment are obtained compared with the resin molded bodies of Examples 25 and 26 where the ratio of the mass is less than 0.45 and more than 0.9.

When the ratio of the mass of the component (B) to the total mass of the component (A), the component (B), and the component (C) is 0.02 or more and 0.5 or less as in the resin molded bodies of Examples 1 to 7, resin molded bodies in which decreases in transparency are suppressed and which have a great ability to maintain their tensile yield strength in a high-humidity/high-temperature environment are obtained compared with the resin molded bodies of Examples 29 and 30 where the ratio of the mass is less than 0.02 and more than 0.5.

When the ratio of the mass of the component (C) to the total mass of the component (A), the component (B), and the component (C) is 0.02 or more and 0.3 or less as in the resin molded bodies of Examples 1 to 7, resin molded bodies in which decreases in transparency are suppressed and which have a great ability to maintain their tensile yield strength in a high-humidity/high-temperature environment are obtained compared with the resin molded bodies of Examples 31 and 33 where the ratio of the mass is less than 0.02 and more than 0.3.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin composition comprising:
a cellulose ester compound (A);
a poly(meth)acrylate compound (B) without a reactive group that reacts with a hydroxyl group of the cellulose ester compound (A); and
a poly(meth)acrylate compound (C) with a reactive group that reacts with a hydroxyl group of the cellulose ester compound (A).

2. The resin composition according to claim 1, wherein the cellulose ester compound (A) is at least one selected from cellulose acetate propionate (CAP) and cellulose acetate butylate (CAB).

3. The resin composition according to claim 2, wherein the cellulose ester compound (A) is cellulose acetate propionate (CAP).

4. The resin composition according to claim 1, wherein the poly(meth)acrylate compound (B) without the reactive group is a poly(meth)acrylate compound including 50 mass % or more of a structural unit derived from an alkyl (meth) acrylate.

5. The resin composition according to claim 4, wherein the poly(meth)acrylate compound (B) without the reactive group is a poly(alkyl (meth)acrylate) having an alkyl chain with 1 or more and 8 or less carbon atoms.

6. The resin composition according to claim 5, wherein the poly(meth)acrylate compound (B) without the reactive group is poly(methyl methacrylate).

7. The resin composition according to claim 1, wherein the poly(meth)acrylate compound (B) without the reactive group is a poly(meth)acrylate compound having a weight-average molecular weight of less than 50,000.

8. The resin composition according to claim 1, wherein the poly(meth)acrylate compound (C) with the reactive group is a compound having, as the reactive group, at least one group selected from a glycidyl group, a dicarboxylic anhydride group, and a carboxy group.

9. The resin composition according to claim 8, wherein the poly(meth)acrylate compound (C) with the reactive group is a polymer of at least one selected from glycidyl group-containing vinyl compounds, unsaturated dicarboxylic anhydrides, and (meth)acrylic acid.

10. The resin composition according to claim 1, wherein a ratio of a mass of the cellulose ester compound (A) to a total mass of the cellulose ester compound (A), the poly(meth)acrylate compound (B) without the reactive group, and the poly(meth)acrylate compound (C) with the reactive group is 0.45 or more and 0.9 or less.

11. The resin composition according to claim 1, wherein a ratio of a mass of the poly(meth)acrylate compound (B) without the reactive group to a total mass of the cellulose ester compound (A), the poly(meth)acrylate compound (B) without the reactive group, and the poly(meth)acrylate compound (C) with the reactive group is 0.02 or more and 0.5 or less.

12. The resin composition according to claim 1, wherein a ratio of a mass of the poly(meth)acrylate compound (C) with the reactive group to a total mass of the cellulose ester compound (A), the poly(meth)acrylate compound (B) without the reactive group, and the poly(meth)acrylate compound (C) with the reactive group is 0.02 or more and 0.3 or less.

13. The resin composition according to claim 10, wherein an amount of the cellulose ester compound (A) relative to the resin composition is 50 mass % or more.

14. The resin composition according to claim 1 further comprising a polyester resin (D).

15. The resin composition according to claim 14, wherein the polyester resin (D) is a polyhydroxyalkanoate.

16. The resin composition according to claim 15, wherein the polyester resin (D) is polylactic acid.

17. A resin molded body comprising the resin composition according to claim 1.

18. The resin molded body according to claim 17, wherein the resin molded body has a haze value of 10% or lower when having a thickness of 2 mm.

19. The resin molded body according to claim 17, wherein the resin molded body is an injection-molded body.
